(19) United States
(12) Patent Application Publication
(10) Pub. No.: US 2014/0025509 A1
(43) Pub. Date: Jan. 23, 2014

(54) METHODS AND APPARATUS FOR BID OPTIMIZATION AND INVENTORY SCORING

(71) Applicant: Media6Degrees Inc., New York, NY (US)

(72) Inventors: Claudia Reisz, Mount Kisco, NY (US); Brian Dalessandro, Brooklyn, NY (US); Rodney Hook, New York, NY (US)

(73) Assignee: Media6Degrees Inc., New York, NY (US)

(21) Appl. No.: 13/945,158

(22) Filed: Jul. 18, 2013

Related U.S. Application Data
(60) Provisional application No. 61/673,223, filed on Jul. 18, 2012.

(51) Int. Cl. G06Q 30/02

(52) U.S. Cl. CPC G06Q 30/0275
USPC 705/14.71

(57) ABSTRACT

Methods for bid optimization and inventory scoring are provided. The method comprises receiving a definition of a success event associated with a campaign that has a set of campaign parameters. The method also comprises calculating an impact estimate for a performance measure of the success event. The impact estimate is calculated based on a set of auction parameters and a set of historical data associated with a browser. The method further comprises defining a bidding function based on the impact estimate, a set of characteristics of the browser, and the set of campaign parameters. The method also comprises calculating, after calculating the impact estimate and defining the bidding function, a bid value using the bidding function. The method also comprises sending a signal having the bid value to a real-time bidding exchange.

### CROSS-REFERENCE TO RELATED APPLICATIONS

This application claims priority to U.S. Provisional Patent Application No. 61/673,223 entitled “Methods, Systems and Media for Bid Optimization and Inventory Scoring”, filed on Jul. 18, 2012, which is incorporated herein by reference in its entirety.

### BACKGROUND

Some embodiments described herein relate generally to optimization of bidding on advertisement opportunities on networks.

Many digital advertisers use real-time bidding exchanges, which allow advertisers to bid on an opportunity to show an advertisement to a specific user at a digital display advertising spot on a website, mobile application, etc. Advertisers typically bid for these advertisement opportunities on behalf of a company or a brand. These bidding decisions are made in fractions of a second after the identification of what location, such as a webpage or mobile application, has a spot available and who may view the advertisement. In addition, data providers typically annotate the inventory of available opportunities to assist advertisers make better targeting decisions. The typical transaction occurs in near real-time to avoid delays loading the webpage or mobile applications and to maintain a good user experience. The strategies for targeting and bidding, however, vary greatly between different advertisers and depend on the data that an advertiser is willing to use and/or capable of using. Furthermore, the strategies suffer from high competition and limited scale.

Therefore, a need exists to overcome the shortcomings of the known methods by determining a bid value that better reflects the value of an advertising opportunity, while providing the right message to the right person at the right time.

### SUMMARY

In some embodiments, a method comprises receiving a definition of a success event associated with a campaign that has a set of campaign parameters. The method also comprises calculating an impact estimate for a performance measure of the success event. The impact estimate is calculated based on a set of auction parameters and a set of historical data associated with a browser. The method further comprises defining a bidding function based on the impact estimate, a set of characteristics of the browser, and the set of campaign parameters. The method also comprises calculating, after calculating the impact estimate and defining the bidding function, a bid value using the bidding function. The method also comprises sending a signal having the bid value to a real-time bidding exchange.

### BRIEF DESCRIPTION OF THE DRAWINGS

FIG. 1 is a schematic block diagram of a computer system in which bid optimization and inventory scoring can be performed, according to an embodiment.

FIG. 2 is a schematic illustration of a bid management system, according to an embodiment.

FIG. 3 is a flowchart of a process for bid optimization and inventory scoring based on a success event, according to an embodiment.

FIG. 4 is a flowchart of a process for bid optimization and inventory scoring based on monitoring information, according to an embodiment.

FIG. 5 is an example of a diagram of campaign properties for an example campaign.

FIG. 6 is an example of a diagram of inventory scores for an example campaign.

### DETAILED DESCRIPTION

Some known online bidding systems typically match a search term (e.g., “car insurance”) to a product to determine whether a browser used for searching the term is a suitable opportunity for an advertisement of that product. For example, a browser may show an advertisement during the time that the user is performing the search as the user can be thinking about the product at that moment. Other known bidding systems associate the content of a webpage with a product. For example, if the browser is currently showing a review about used cars, an opportunity may exist to present an advertisement on used cars or auto insurance. This approach, however, typically works only for a small set of well-understood content and clearly-defined products. Moreover, many of the known systems suffer from high competition and limited scale.

Methods and apparatus are described herein for bid optimization and inventory scoring for online advertisement opportunities. In some embodiments, a method comprises receiving a definition of a success event associated with a campaign that has a set of campaign parameters. The method also comprises calculating an impact estimate for a performance measure of the success event. The impact estimate is calculated based on a set of auction parameters and a set of historical data associated with a browser. The method further comprises defining a bidding function based on the impact estimate, a set of characteristics of the browser, and the set of campaign parameters. The method also comprises calculating, after calculating the impact estimate and defining the bidding function, a bid value using the bidding function. The method also comprises sending a signal having the bid value to a real-time bidding exchange.

In some embodiments, a method comprises sending, to a browser, monitor information (e.g., a cookie, a file, data with a unique browser-identifier, etc.) configured to record a set of events associated with the browser and a set of interaction sites. The method also comprises receiving monitor information associated with the browser and based on the monitor information. The method further comprises associating the browser with a segment from a set of segments based on the monitor information. The method also comprises calculating an impact estimate for a performance measure based on a set of auction parameters and the segment. The method also comprises defining a bidding function based on the impact estimate, the segment, and a set of campaign parameters. The method further comprises calculating, after calculating the impact estimate and defining the bidding function, a bid value using the bidding function. The method also comprises sending a signal having the bid value to a real-time bidding exchange.

In some embodiments, a method comprises calculating an impact estimate for a performance measure of a success event associated with a campaign. The calculation is based on a set of parameters of an auction for the campaign and a set of historical data associated with a browser. The method also comprises defining a bidding function based on the impact estimate, a set of characteristics of the browser, and a set of parameters associated with the campaign. The method also comprises calculating, after calculating the impact estimate and defining the bidding function, a bid value using the bidding function based on the set of parameters associated with the campaign and a value of inventory for the auction. The method further comprises sending a signal having the bid value such that the bid value is submitted to a real-time bidding exchange executing the auction.

As used herein, “user” can be a person, a module, a device, an application, or any entity that accesses a network location. In some of the embodiments discussed, a user refers to a person using a user device via one or more user interfaces. Additionally/alternatively, a user can refer to a device, a module of a device, or an application such as, for example, a bidding application, an advertisement engine, a browser, etc., that can provide bid opportunities (e.g., one or more inventories) that can be managed by the described methods and system.

As used herein, the singular forms “a,” “an” and “the” include plural referents unless the context clearly dictates otherwise. Thus, for example, the term “a “success event” is intended to mean a single success event or multiple success events (e.g., success events with similar campaign parameters or similar impact estimates, etc.).

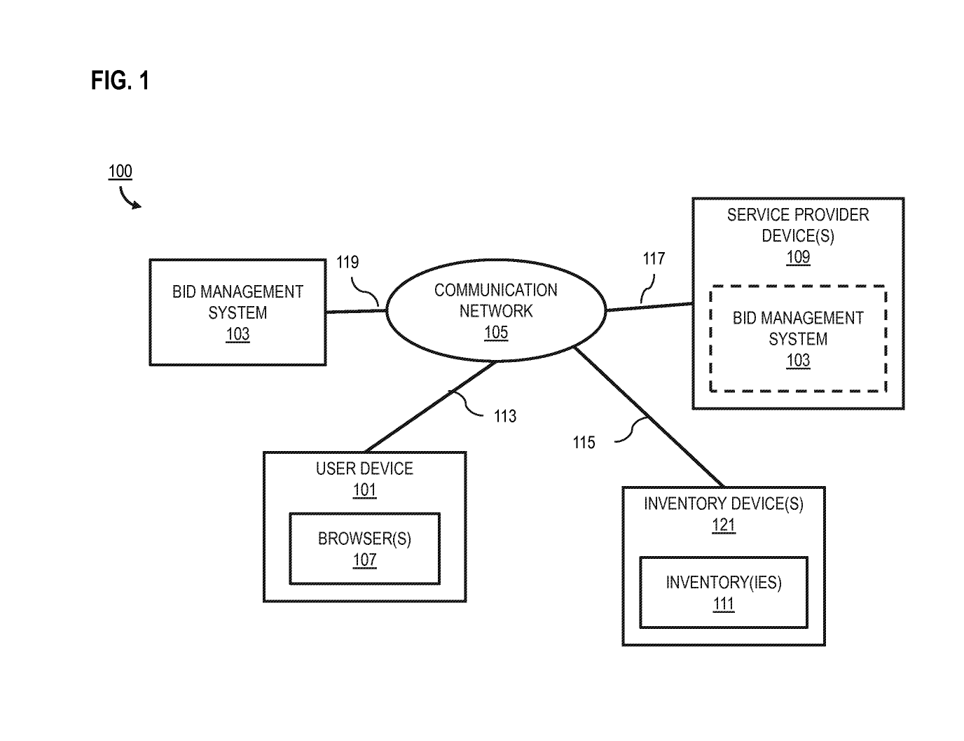

FIG. 1 is a schematic block diagram of a computer system in which bid optimization and inventory scoring can be performed, according to an embodiment. The computer network system 100 includes at least one user device 101, which can have one or more browser(s) 107; a bid management system 103; and a communication network 105. The computer network system 100 further includes at least one service provider device(s) 109, which can be operatively coupled to one or more user device 101 or other service provider device(s) 109 via the communication network 105; and at least one inventory device 121, which can be operatively coupled to service provider device(s) 109 via the communication network 105.

An inventory device 121 can be a storage device having one or more databases or inventory(ies) 111. An inventory 111 can be a set of indicators, representations, or links to available locations (e.g., browser locations, locations within websites, locations within applications, etc. as discussed below) where advertisements can be displayed. For example, the online version of a newspaper can include locations where advertisements can be displayed, and an inventory or a set of inventories can indicate, represent or link to these locations. For another example, blogs and other online sites can have available space or locations for advertisements, an inventory or a set of inventories can indicate, represent or link to these locations. Similarly, software applications can provide spaces or locations on their displays, menus, etc., to display advertisements; an inventory or a set of inventories can indicate, represent or link to these locations. An advertisement can be any form of communication for marketing a product, brand, service, etc. For example, an advertisement can include one or more of an audio, video, banner, poster, text script, text message, image, etc. For example, an advertisement can also be a mobile advertisement targeting mobile user devices 101.

A service provider device 109 can be a server, controlled by an advertisement provider, that can execute an advertising campaign (e.g., a series of advertisement messages that share an idea(s)/theme(s) and can appear in different media across a specific time frame). The service provider 109 can provide communication between advertisers (not shown in FIG. 1), users of user devices 101, inventory device(s) 121 and data providers (not shown in FIG. 1), for example, by executing advertisement campaigns or running advertisement auctions. An advertisement auction can be used to select advertisements to appear on available locations (e.g., indicated by inventory(ies) 111). Furthermore, an advertisement auction can have various parameters, for example, defined by an owner of the available locations indicated by inventory(ies) 111. The auction parameters can be, for example, auction type, policies, strategies, base bid values, etc. The result of an auction can be an impression (e.g., showing of an advertisement by an advertiser with highest bid on the inventory(ies) 111 to a browser 107 of the user device 101). For example, a service provider 109 can be a server provided by an organization that provides advertisements to the user devices 101. A service provider 109 can be organized in various categories such as, for example, commercial, community owned, non-profit, privately-owned, etc.

The bid management system 103 can collect data associated with events related to advertisements, advertisers, user devices 101, browsers 107, inventory(ies) 111, inventory device(s) 121, etc., and analyze that data to estimate advertisement impact, calculate optimized bid values, calculate inventory scores (e.g., effectiveness and relevance), etc. The results of analysis by the bid management system 103 can be used by the service provider device(s) 109 to provide advertisements to user devices 101.

Note that the bid management system 103 or some of its components can be embedded within the service provider device(s) 109, or be external to the service provider device(s) 109, and operatively coupled to one or more user device 101 one or more service provider device(s) 109 via the communication network 105. Any of the devices or platforms of the computer network system 100 can be equipped with local memory/storage spaces (not shown in FIG. 1). Furthermore, the devices and platforms of the computer network system 100 can have access to centralized or distributed memory/storage spaces (not shown in FIG. 1) for example through the communication network 105. Additionally, a user device 101, a bid management system 103, a service provider device(s) 109, and an inventory device 121 each can include one or more processors, performing processes associated with the services provided to the user device 101 (each not shown in FIG. 1). Thus, FIG. 1 is merely an example illustrating the types of devices and platforms that can be included within a computer network system 100.

Communication network 105 can for example be any communication network, such as the Internet, configurable to allow the user device 101, the bid management system 103, the service provider device(s) 109, and the inventory device(s) 121 to communicate with communication network 105 and/or to each other through communication network 105. Communication network 105 can be any network or combination of networks capable of transmitting information (e.g., data and/or signals) and can include, for example, a telephone network, an Ethernet network, a fiber-optic network, a wireless network, and/or a cellular network.

In some instances, communication network 105 can include multiple networks operatively coupled to one another by, for example, network bridges, routers, switches and/or gateways. For example, the user device 101 can be operatively coupled to a cellular network; the service provider device(s) 109, the bid management system 103 and/or the inventory device(s) 121 can be operatively coupled to a fiber-optic network. The cellular network and fiber-optic network can each be operatively coupled to one another via one or more network bridges, routers, switches, and/or gateways such that the cellular network and the fiber-optic network are operatively coupled to collectively form a communication network. Alternatively, the cellular network and the fiber-optic network can each be operatively coupled to one another via one or more additional networks. For example, the cellular network and the fiber-optic network can each be operatively coupled to the Internet such that the cellular network, the fiber-optic network and the Internet are operatively coupled to form a communication network.

As illustrated in FIG. 1, the user device 101 is operatively coupled to communication network 105 via network connection(s) 113; inventory device(s) 121 is operatively coupled to communication network 105 via network connection(s) 115; service provider device(s) 109 is operatively coupled to communication network 105 via network connection(s) 117; and the bid management system 103 is operatively coupled to communication network 105 via network connection(s) 119. Network connections 113, 115, 117, and 119 can be any appropriate network connection for operatively coupling user device 101, inventory device(s) 121, service provider device(s) 109, and the bid management system 103.

For example, network connections 113, 115, 117, and 119 each can be a wireless network connection such as, for example, a wireless fidelity (“Wi-Fi”), a wireless local area network (“WLAN”) connection, a wireless wide area network (“WWAN”) connection, and/or a cellular connection. Alternatively, network connections 113, 115, 117, and 119 each can be a wired connection such as, for example, an Ethernet connection, a digital subscription line (“DSL”) connection, a broadband coaxial connection, and/or a fiber-optic connection.

As mentioned above, in some instances, a computer network system 100 can include more than one user device 101, more than one bid management system 103, more than one inventory device(s) 121, and more than one service provider device(s) 109. A user device 101, a bid management system 103, an inventory device 121, and/or a service provider device(s) 109, can be operatively coupled to the communication network 105 by heterogeneous network connections. For example, a first user device 101 can be operatively coupled to the communication network 105 by a WWAN network connection, another user device 101 can be operatively coupled to the communication network 105 by a DSL network connection, and a bid management system 103 can be operatively coupled to the communication network 105 by a fiber-optic network connection. The service provider device(s) 109 can be, for example, a web server configured to provide various applications to electronic devices, such as user device 101.

The user device 101 can be any of a variety of electronic devices that can be operatively coupled to communication network 105. A user device 101 can be for example a personal computer, a tablet computer, a personal digital assistant (PDA), a cellular telephone, a smart phone, a TV, a portable/mobile Internet device and/or some other electronic communication device. The user device 101 can include one or more web browser(s) 107 configured to access a webpage or website location hosted on or accessible via the service provider device(s) 109 over communication network 105. In addition or alternatively, the user device 101 can include a geolocation functionality that provides signals or indications of the location of the user device 101 to communication network 105 and/or bid management system 103. In such instances, the signals or indications of the location of the user device 101 can be used by the bid management system 103 to determine when the user device 101 (and the user) is located near or within, for example, a particular location such as a retail location.

The user device 101 can be configured to support, for example, HyperText Markup Language (HTML) using JavaScript. The user device 101 can include a web browser such as, for example, Internet Explorer®, Firefox®, Safari®, Dolphin®, Opera® and Chrome®. An Internet page, webpage, website location, an online video, a software application, etc. (e.g., indicated in inventory(ies) 111) can be accessed by a user of a browser 107 at a user device 101 by providing the browser 107 with a reference such as a Uniform Resource Locator (URL), for example, of a webpage. In some instances, user device 101 can include specialized software for accessing a web server other than a browser, such as, for example, a specialized network-enabled application or program. In some instances, portions of a website location accessible via a web server can be located in a local or remote memory space/data store accessible to the web server. The portions of the website location can be stored in the memory/data store in a database, a data warehouse, a file, etc. A user device 101 can also include a display, monitor or user interface (not shown in FIG. 1), a keyboard, various communication or input/output (I/O) ports (e.g., a USB port), and other user interface features, such as, for example, digital pens, mice, touch screen controls, audio components, and/or video components (each not shown). A user device 101 can be operatively coupled to communication network 105 via a user interface and a network connection 113.

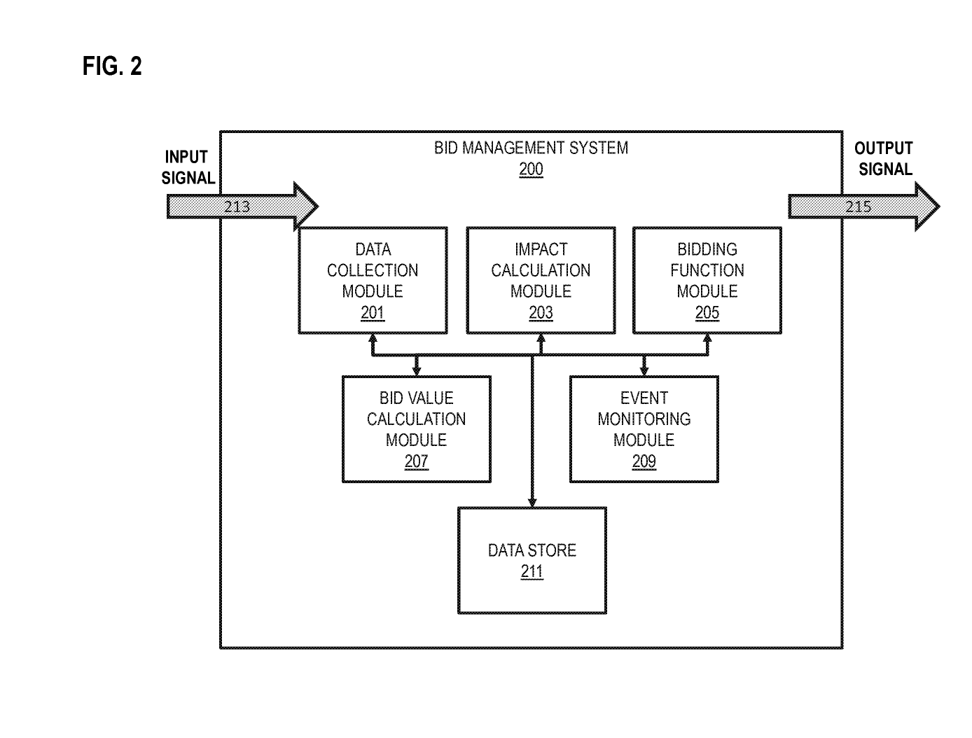

FIG. 2 is a schematic illustration of a bid management system, according to an embodiment. Bid management system 200 can be similar to the bid management system 103 of FIG. 1. As shown in FIG. 2, a bid management system 200 can include a data collection module 201, an impact calculation module 203, a bidding function module 205, a bid value calculation module 207, an event monitoring module 209 and a data store 211. In various instances, the bid management system 200 and its components can be located anywhere within a communication network system 100 such as that shown in FIG. 1 including, but not limited to, within the service provider device(s) 109, or in separate network locations within the communication network system 100 of FIG. 1. Furthermore, the bid management system 200 can communicate with other components of a network system 100 via input signal(s) 213 and output signal(s) 215

As used herein, a module can be, for example, any assembly and/or set of operatively-coupled electrical components, and can include, for example, a memory, a processor, electrical traces, optical connectors, software (executing or to be executed in hardware) and/or the like. Furthermore, a module can be capable of performing one or more specific functions associated with the module, as discussed further below.

As used herein, an interaction site can be any location visited by a user of a user device 101, for example, using a browser 107 or by the user itself. For example, an interaction site can be a webpage associated with a product or brand, an arbitrary online location associated with a product or brand, etc. For another example, an interaction site can be a physical location associated with a product or brand such as a retail store that is associated with a particular brand or that sells a particular product or brand of products. An interaction site can also be an application (e.g., a software application) installed on or remotely accessed by the user of the user device 101.

The bid management system 200 can provide bid optimization and scoring of inventory(ies) 111 of the inventory device(s) 121, of FIG. 1 for advertisement targeting by a service provider device 109. For example, the data collection module 201 can receive (e.g., from an advertiser (not shown), from a service provider device 109, etc.) a definition of a success event associated with an advertisement campaign. The success event can include, or be associated with, factors that define a successful advertisement (e.g., leading to a product purchase/order). The data collection module 201 can also receive campaign data from the service provider device 109. The campaign data can include data used by a service provider device 109 for segmenting the inventory(ies) 111 for user devices 101. The campaign data can also include data on browser(s) 107, data related to various campaign parameters (e.g., campaign cost structure (Cost Per Thousand impressions (CPM), Cost Per Action (CPA), cost+, etc.), total delivery goal, geo targeting, base bid values, black-listing or white-listing of specific URLs, constraints on visibility, etc.), success events (e.g., a click on an ad, a brand online purchase, a visit to a website related to a brand, a brand-relevant action associated with a browser, etc.) of the campaign based on the campaign parameters, etc., to be used by the bid management system 200, for example, for scoring the inventory(ies) 111. The data collection module 201 can receive the data via input signal(s) 213 and store the received data in data store 211.

In some instances, the bid management system 200 can apply various analyses (e.g., machine learning analysis) on the collected data to identify browser(s) 107 with a particular level of interest in a brand or a particular likelihood of purchasing a product. For example, the impact calculation module 203 can calculate an impact estimate for an inventory 111, for one or more segments of an inventory 111, for a group of inventory(ies) 111, for a success event, etc. based on the data related to a browser 107, the campaign parameters, etc. The impact estimation for an advertisement event includes calculating an effect of the advertisement on viewers (e.g., users of user devices 101) such that the viewers are likely to remember the product. An impact estimate can also include a change in a performance measure for a browser 107 and a given campaign (specifically, change in probability of success events). The impact calculation module 203 can use auction parameters, campaign data, historical data of browsers 107, etc. to estimate the impact (or effect) of an advertisement. The estimated impact can be used for optimizing bid values and for scoring inventory(ies) 111. The impact calculation module 203 can store the impact estimate in data store 211.

The historical data of browser 107 can include, for example, data associated with various interactions between the browser 107 and interaction sites (e.g., website locations) regardless of whether the interaction sites include an advertisement or not. In other words, the historical data of browser 107 can include, for example, information about which ULRs were accessed by browser 107. The historical data of browser 107 can also include for example information about which advertisements were previously viewed or accessed by browser 107, or information about which advertisements for a given campaign were previously viewed or accessed by browser 107, but such information is not necessary and the calculation of the impact estimate is need not use such information (e.g., a learning phase based on such information is not needed). In another example, the historical data of browser 107 can include, for example, information about which physical locations associated with a product or brand were visited or accessed by (or in proximately to) a user of the user device 101 having browser 107 based on the geolocation information of the user device 101 over some prior period of time. Similar to the discussion above, such historical information can be used to calculate the impact estimate, but such a calculation of the impact estimate need not use information about which advertisements were previously viewed or accessed by browser 107 or information about which advertisements for a given campaign were previously viewed or accessed by browser 107.

The bidding function module 205 can define a bidding function for an inventory 111, for one or more segments of an inventory 111, for a group of inventory(ies) 111, etc., based on the impact estimate associated with that inventory 111, for one or more segments of the inventory 111, for the group of inventory(ies) 111, etc. The bidding function module 205 can also use data related to a browser 107, the campaign parameters, etc., for defining the bidding function. A bidding function can map the impact estimate to a bid value for the inventory 111, for the one or more segments of the inventory 111, for the group of inventory(ies) 111, etc. In some instances, the bid value calculation module 207 can use the bidding function to calculate a bid value based on the impact estimate, the data related to a browser 107, the campaign parameters, etc. For example, the bid value calculation module 207 can use various bid optimization methods to determine the bid value based on the impact estimate associated with a quality of the inventory 111 or advertisement opportunity.

The event monitoring module 209 can monitor browser(s) 107 by sending a monitor information to each browser 107. The monitor information can be, for example, a cookie that contains a random identifier assigned to the browser 107. The monitor information can cause events related to the browser 107 with respect to various interaction sites to be recorded locally and/or remotely. Note that The events related to the browser 107 can include, for example, at least one of a Uniform Resource Location (URL) identifier selected by the user, a URL type of a URL selected by a user, purchase information, information related to a user agent, conversion information, etc. For example, conversion information can include information indicating a visit to a marketer's website, code that has been downloaded, a service to which a user subscribed, a product purchased by a user, etc. The event monitoring module 209 can receive monitoring information related to the browser 107 from, or caused by, the monitor information and associate the browser 107 with a campaign segment based on a segment score calculated from the monitoring information. For example, the event monitoring module 209 can use browsing history of a browser 107 to score the browser 107 for active advertising campaigns. This score can be stored locally at data store 211 and/or remotely at any location throughout the computer network system 100. If a browser 107 scores high enough for one or more campaigns (e.g., the browser score is higher than a predetermined threshold), that browser 107 is assigned to or associated with a segment of the campaign. For example, an indicator of that browser 107 can be associated with an indicator of that campaign segment. Each campaign can have multiple segments with different score thresholds and different advertisement models, defined by an advertiser, vendor, etc. An online advertisement model can, for example, be Cost Per Click (CPS), Cost Per Order (CPO), CPM, CPA, Cost Per Lead (CPL), etc. Typically only about 1% of browsers 107 qualify for any segment of a given campaign.

In some instances, the event monitoring module 209 can monitor the browser 107 (for example by sending a monitor information to the browser 107 to record or cause recording of events associated with the browser 107). For example, a recorded or caused event by the monitor information can indicate that the browser 107 has converted (e.g., responded to the advertisement, for example, by an online purchase of an advertised product) during a conversion period. For example, a post-view conversion can be measured within a defined period of time between the advertisement impression and the occurrence of a particular conversion action.

In some instances, the event monitoring module 209 can periodically send updated monitoring information related to the browser 107 to the bid value calculation module 207. The bid value calculation module 207 can use the monitoring information to calculate the bid values. Furthermore, when a service provider device 109 receives bid requests (e.g., from an advertiser) for a browser 107 indicated by an inventory 111, the bid value calculation module 207 can receive (or request) updated monitoring information from the event monitoring module 209. The bid value calculation module 207 can calculate a new bid value or adjust an existing bid value based on the updated monitoring information for new bid requests. In another example, events that can be used by the bid value calculation module 207 to adjust a bid value can include an exact placement of an advertisement, a size of the advertisement, an amount of time that an advertisement is displayed, other suitable information related to the interaction site, etc. Furthermore, the bid value can be adjusted, for example by the bid value calculation module 205, proportionally to the impact estimate corresponding to the advertising opportunity. For example, if showing an advertisement on a particular location indicated by an inventory 111 (e.g., a browser segment) doubles the probability of conversion over a random inventory location, the bid value can be adjusted, for example, to be twice the average bid value.

In some instances, campaign data including, inventory data, segment data, etc., can be stored in a lookup table, for example, in the data store 211. In such instances, the modules of the bid management system 200 can use the lookup table to access data used to calculate the impact estimate, inventory score, and bid value for an advertisement.

In some instances, the final bid value can be a function of the impact estimate and the inventory score. For example, a step function can be applied to the inventory score to obtain a factor applied to the bid value. For example, an inventory score below 0.9 can yield a bid value of 0, which means he advertising opportunity should not be bid. In another example, an inventory score between 0.8 and 1.2 can be set to 1 and an inventory score greater than 1.2 can be set to 2 (which means the advertising opportunity should be bid at twice the assigned bid value).

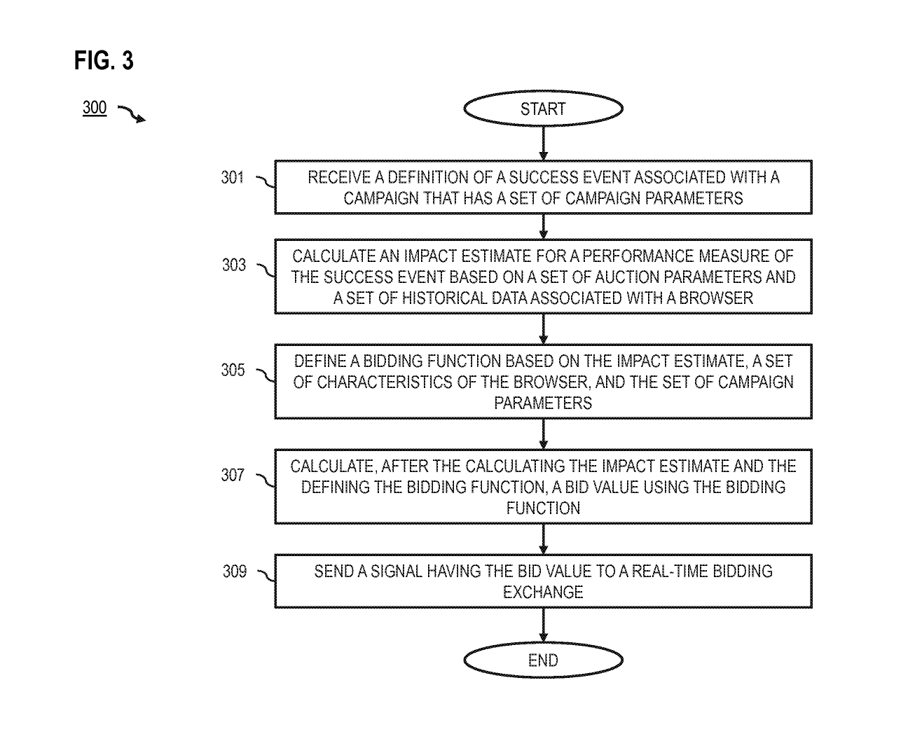

FIG. 3 is a flowchart of a process for bid optimization and inventory scoring based on a success event, according to an embodiment. At 301, a definition of a success event associated with an advertisement campaign is received, for example, by the data collection module 201 of FIG. 2. As previously discussed, a success event can include, or be associated with, factors that define a successful advertisement (e.g., leading to a product purchase/order). The advertisement campaign can have a set of campaign parameters such as, for example, identity of the advertiser, site, publication, advertising or marketing medium (e.g., Cost Per Click (CPC), banner, email newsletter, etc.), the individual campaign name, slogan, promo code, etc. for a product, search keywords, etc. The success event can be defined based on the campaign parameters and can be stored in data store 211.

At 303, an impact estimate for a performance measure (e.g., an aggregation of) the success event is calculated, for example by the impact calculation module 203 of FIG. 2, based on a set of auction parameters (e.g., auction type, policies, strategies, base bid values, for example, set by advertisers, identity of an inventory, time of day, identity of real-time bidding exchange, type of inventory (aka “creative”), base bid value of the inventory, etc.) and a set of historical data associated with a browser 107 (e.g., list of webpages recently visited and associated data such as page title, time of visit, etc.) of a user device 101 of FIG. 1. The objective of advertising is to increase the propensity of browser 107 to convert. The impact of an advertisement can be calculated based on perceptiveness of the advertisement (e.g., the probability that a browser 107 perceives an advertisement). For example, while considering a correct syntax of a query language on a forum page, a user is less likely to take note of an advertisement impression on a side bar than if the user is viewing news stories. The impact of an advertisement can also be calculated based on an impression quality (e.g., the actual time that an advertisement impression is in view). For example, various factors can affect viewability of an advertisement. Some of these factors include taking too long for the impression to load, the impression being displayed below the fold or in some other invisible part of the page, etc.

At 305, a bidding function is defined, for example, by the bidding function module 205, based on the impact estimate, a set of characteristics of the browser 107, and the set of campaign parameters. A bid function can map the impact estimate, browser characteristics (e.g., segment(s) assigned to browser for the campaign, age of the browser cookie, user device parameters (e.g., operating system, type), connection parameters (e.g., provider, Internet Protocol (IP), connection speed, etc.), URLs visited prior to an auction, action(s) taken prior to an auction, impression(s) displayed prior to an auction, etc.) and/or the campaign parameters to one or more bid values.

At 307, a bid value is calculated, for example by the bid value calculation module 207, based on the impact estimate and the defined bidding function. The bid value can represent the value of an inventory available for placing the advertisement. When calculating a bid value, the quality of browser(s) 107 that are observed at a piece of inventory may be different across inventory(ies) 111.

At 309, a signal having the calculated bid value is sent by the bid management system 200, for example, via an output signal 215, to a real-time bidding exchange. In some instances, the bidding function defined at step 305 can be defined based on at least one of (1) an expected value of an auction associated with the campaign, (2) a product of a base bid value associated with the auction and a relative value of the auction (e.g., a value of the auction relative to the average value across a set of relevant auctions), (3) a step function on the relative value of the auction, or (4) a monotonic transformation of an opportunity of the auction. An auction opportunity can, for example, be an event through which an advertiser can submit a bid, winning of which can lead to an advertisement impression associated with the advertiser to be shown on a browser 107 of a user device 101.

In some instances, the campaign can be associated with a brand. In such instances, the success event can be at least one of (1) a click, selection or user input, at a user device 101 on an advertisement associated with the brand, (2) an online purchase associated with the brand at a user device 101, (3) a visit to a website associated with the brand at a user device 101, for example, via a browser 107, or (4) an action (e.g., initiating a search related to the brand by the user, commenting on the brand on a social media, reviewing the brand on a website, etc.) associated with the brand and at a user device 101 on which an impression associated with the brand was displayed. Furthermore, in such instances, the set of characteristics of the browser 107 can include information representing a bid request submitted to the service provider device 109 by the browser 107 before calculating the impact estimate by the bid management system 200 and associated with the brand, and information representing an action associated with the browser 107 and associated with the brand. Additionally, in such instances, the set of characteristics of the browser 107 can include information representing one or more impressions displayed at the browser 107 before calculating the impact estimate, for example by the bid management system 200, and associated with the brand, and information representing an action associated with the browser 107 and associated with the brand. Also, in such instances, the bid value can be based on a ratio of (1) a probability of the success event given the browser and an auction inventory 111 and (2) an expected probability of the success event given the browser 107 divided for auction inventory(ies) 111. In such instances, the probability of the success event and the expected probability of the success event each can be based on information representing auctions before calculating the impact estimate and information representing visits to a website associated with the brand. The auctions can be auctions for the same browser 107 with various possible settings the expected values of which can be calculated using empirical distribution.

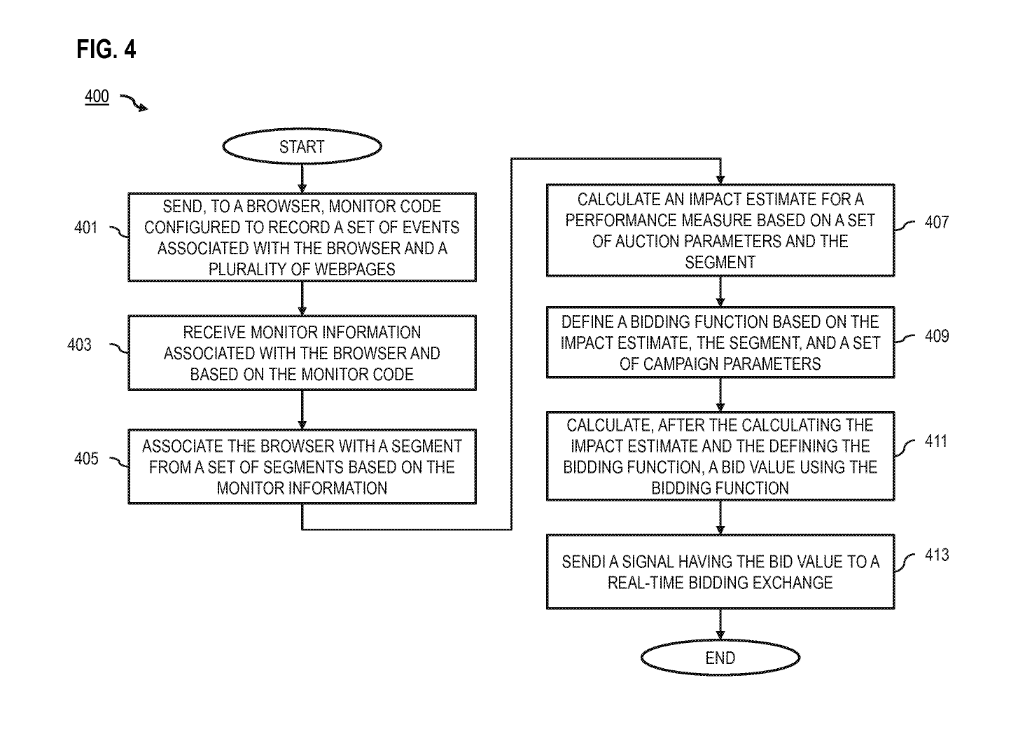

FIG. 4 is a flowchart of a process for bid optimization and inventory scoring based on monitoring information, according to an embodiment. At 401, a monitor information is sent to a browser 107, for example, by the event monitoring module 209 of FIG. 2. The monitoring information is configured to record or cause the recording of a set of events associated with the browser 107 and a set of interaction sites. The events can be stored in data store 211.

At 403, monitor information associated with the browser and based on the monitor information is received, for example, by the data collection module 201. The monitoring information can include, for example, the recorded set of events. The monitoring information can be stored in data store 211.

At 405, the browser 107 of a user device 101 is associated with a segment of an advertisement campaign from a set of segments based on the monitor information, for example, by the data collection module 201, as previously discussed with regards to FIG. 2. At 407, an impact estimate for a performance measure is calculated based on a set of auction parameters and the segment associated with the browser 107, similar to previous discussion with regards to step 303 of FIG. 3.

At 409, a bidding function is defined, for example by the bidding function module 205, based on the impact estimate, the segment, and a set of campaign parameters, similar to previous discussion with regards to step 305 of FIG. 3.

At 411, a bid value is calculated, for example by the bid value calculation module 207, based on the impact estimate and the defined bidding function, as previously discussed with regards to step 307 of FIG. 3. At 413, a signal having the calculated bid value is sent by the bid management system 200, for example via an output signal 215, to a real-time bidding exchange. The real-time bidding exchange can use the calculated bid value to optimize bid values for available advertisement opportunities (e.g., inventory(ies) 111).

The following provides a more detailed discussion of bid optimization and inventory scoring by the bid management system 200 of FIG. 2. In some instances, browser(s) 107 of user devices 101 are observed (e.g., browser data is collected by the data collection module 201 of FIG. 1) periodically (e.g., multiple times during the day) while a user u is browsing different websites. A value of an opportunity O can be calculated based on the collected browsing data. An opportunity O can be shown by a triplet O=(u, a, i) of an advertisement a, for a marketer to a user u (e.g., of a user device 101) at a particular inventory i. The inventory i can be similar to an inventory 111 of FIG. 1.

In some instances, a bid value B can be adjusted according to a value of the opportunity O. Note that a relation exists between the inventory i and the user's probability of converting. In some instances, the mere fact that a user u visits a particular inventory i can affect an estimate of a conversion probability by the user u.

Various factors can affect the bid value B. A first factor can be contextual relevance. A correlation exists between the content of the inventory i and the product or the brand advertised. A purely-contextual targeting approach by the bid management system 200 can take only the current content of the inventory URL into account when making a targeting decision. A second factor can be current intentions of user u. For example, if the browser 107 is engaged in online shopping by user u, the probability that the user u of browser 107 will purchase from a marketer (regardless of the impression) is notably higher than when the user u is involved in an activity completely unrelated to shopping. A third factor can be life expectation. In some instances, a correlation can exist between the type of inventory i a user u sees and the probability of the user deleting the cookie associated with an advertisement (e.g., the monitor information received at the browser from the event monitoring module 209 of FIG. 2). While this relationship can be insignificant for most inventories i, it can be notable for some inventories i. As a result of an increased probability of cookie deletion, the probability of observed conversion can be lower.

In some instances, interactions between the inventory i and causal effect of showing an advertisement on a browser 107 can be measured as a fourth factor. An inventory can be related to the probability that a user u perceives an advertisement. For example, while looking for the correct syntax of a Structured Query Language (SQL) query on a forum page, a user u is much less likely to take note of an advertisement impression on the side of the display than when the user u is browsing around in news stories. Perception of external stimuli decreases significantly when the mind is focused on a specific task.

A fifth factor can be an impression quality. In some instances, the actual time that an impression is in view can be measured. Note that few impressions may be actually seen (e.g., defined as being in the visible part of the page and actually displayed for at least 2 seconds) by the browser 107. Potential reasons for lack of viewability can be that it may take too long for the impression to load or that the impression is displayed below the fold or in some other invisible part of the page.

The set of factors discussed above can be quantified and analyzed by the bid management system 200 to evaluate an inventory i and calculate a bid value for the inventory i. The value of an opportunity O to show an advertisement to a particular user u depends on the objectives of the marketer and the advertisement a. In an auction-theoretic framework, the optimal bid value of a second-price auction can be determined by the expected value of the outcome:

P(c|u,a,i)*V(c) (1)

where c is a success event and V(c) is the value of the success event c. In some instances, the success event c can be a conversion event associated with an advertisement. In other instances, however, a visit to an interaction site from inventory i can be a success event, even if the user u does not respond to any advertisements on the interaction site or if no advertisements are shown on the interaction site. For online targeting, V(c) plays a minor role in bid optimization. For various purposes, V(c) is typically unknown or simply assumed to be constant across users u. Note that the value of the opportunity O can be proportional to the probability of the success event. This implies that the bid value B can be proportional to the probability as well. In some instances, the bid can be modified proportionally to the effect of the inventory i. For example, if showing an advertisement on a particular piece of inventory i doubles the probability of the success event over some random inventory j, the bid value B* for inventory i can be defined as twice the average bid value B.

$${Φ}^{*} = \frac{p ( c \vert u , i , a )}{{E}_{j} [ p ( c \vert u , j , a ) ]} \qquad ( 2 )$$

The Equation (2) is independent from a campaign's base rate of the success event. In particular, the bid value calculation module 207 can integrate the equation (2) with the base bid value B as a multiplier as seen in equation (3).

B*=B*Φ* (3)

In some instances, for a definition of bid value B*, the bid value calculation module 207 can compare the outcome of serving an advertisement at inventory i to the expectations over various counterfactual events of showing the advertisement at a different inventories j.

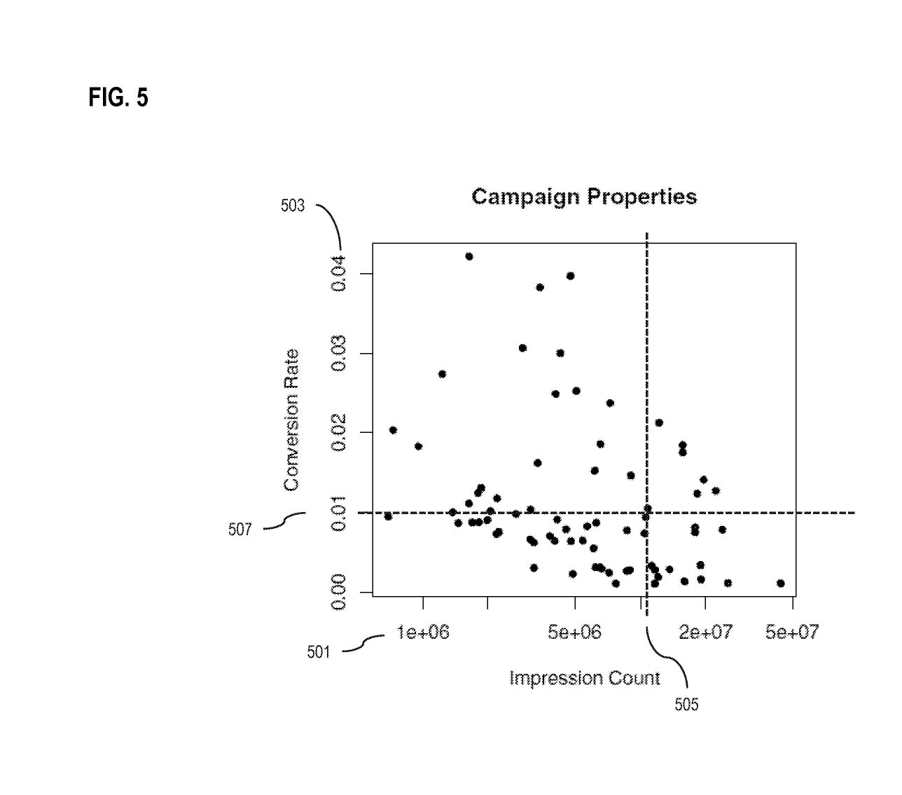

FIG. 5 is an example of a diagram of campaign properties for an example campaign. In some instances, information on a user u is known at the time of an auction. The user information can include the identity of a user u using browser 107. In addition, other information can be retrieved from or caused by the monitor information, provided by the event monitoring module 209, to estimate pₐ(c|u, i). A highly optimized and pre-calculated estimate of the user's propensity to convert an advertisement impression pₐ(c|u) can be defined based on assigning the browser 107 to a segment s of desirable prospects for a given campaign. Given the time constraint of a real-time auction (e.g., where one of the worst case scenarios is timing out and not being able to bid) the relevant user information can be the segment s to which the user is assigned.

In some instances, for estimating inventory scores for a given campaign, a sample of impressions delivered across multiple inventories can be used, for example, by the impact calculation module 203 of the bid management system 200 along with the segment information of each targeted user u. In addition, each impression can be tracked to find whether or not the user u converted according to the rules of the campaign. For a campaign where the marketer desires evaluating the click through rate, the clicks can be used as positive impacts. Similar to the discussion above regarding historical data for a browser, the estimating of inventory scores can be based on such historical data about which user had accessed which inventory. That said, the estimating of inventory scores need not include information about any impression or information about any impression for a given marketer (or advertiser) of a given interest (e.g., campaign, product or brand).

In the example of FIG. 5, it is assumed that 5,000 unique inventories exist across 20 exchanges, about 1,000 of which have notable volume. In addition, it is assumed that the average campaign uses between 10 and 50 different segments. The estimation of inventory score in its simplest form has an effective dimensionality of greater than or equal 1,000. Considering interaction terms, the dimensionality can grow by an order of magnitude as seen in axis 501 of FIG. 5.

The conversion rates 503, on the other hand, can be typically low and range, for example, between 0.04 in the best case and below 0.001 for other cases. This implies that the desirable amount of data for estimation of inventory score can be rather large. As a result, impression data for a time period (e.g., several weeks) can be used. FIG. 5 shows impression counts 501 and conversion rates 503 for several campaigns. As seen in FIG. 5, showing, on average, 15 million impressions (shown as 505) to user u results in about 250,000 conversions at an average conversion rate of 1% (shown as 507).

In some instances, p(c|s,i) can be estimated using L1-constrained logistic regression (with the default penalty weight). Having an L1 penalty implicitly selects only the relevant features and provides a sparse solution. For many inventories, the parameter is set to zero and as a result the estimated impact factor is 1 and will not change the bid value. Additionally, an initial filter can be applied including an inventory feature only if its volume is sufficient to yield at least a pre-determined number of conversions in expectation given the base conversion rate of the campaign. Otherwise, it can be assigned to a default ‘other’ bucket.

In some instances, there is a strong non-monotonic interaction effect between the conversion rate p(c|s) and the inventory i. The inventory can be of high quality with the impression in view or not. In some instances, empirical distribution of j in the data is used for estimation of equation (2).

Eⱼ[p(c|u,j,a)]˜\hat{p}ₐ(c|a) (4)

Equation (4) can be used as a baseline to evaluate whether there is any predictive information in the inventory i that can be used by the bid management system 200.

In some instances, a marketer can predict \hat{p}ₐ(c|s,i) and/or predict pₐ(c|i) for an advertisement a. However, the two predictions need calibration due to the initial down-sampling of negative impacts. The corrected prediction can be shown as equation (5).

$${\hat{Φ}}_{a}^{*} ( i , s ) = \frac{{\hat{p}}_{a} ( c \vert s , i )}{{\hat{p}}_{a} ( c \vert s )} \qquad ( 5 )$$

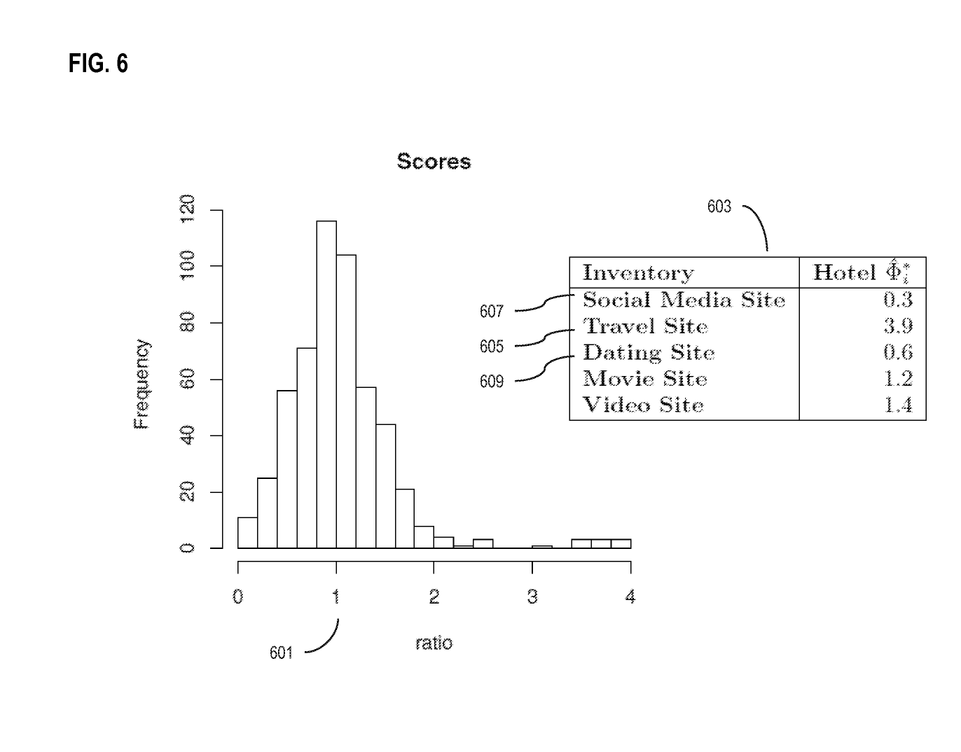

FIG. 6 is an example of a diagram of inventory scores for an example campaign. FIG. 6 shows the distribution of the estimates of \hat{Φ}ᵢ* across inventories i for an example campaign for a hotel chain. In this example, the scores (e.g., estimated impacts calculated by the impact calculation module 203) are well-calibrated around 1 (shown as 601) and show promising signal for inventory that represents travel sites (605). Table 603 shows example scores (e.g., impacts) for the hotel chain campaign. As seen in FIG. 6, the travel sites have a high score (shown as 605). On the other hand social media sites 607 and dating sites 609 do not seem very suitable for hotel advertisement. They probably score low across multiple dimensions of inventory impact (e.g., bad target, low on current intent and low on perceptiveness).

It is intended that the methods and apparatus described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

While various embodiments have been described above, it should be understood that they have been presented by way of example only, and not limitation. Where methods and steps described above indicate certain events occurring in certain order, the ordering of certain steps may be modified. Additionally, certain of the steps may be performed concurrently in a parallel process when possible, as well as performed sequentially as described above. Although various embodiments have been described as having particular features and/or combinations of components, other embodiments are possible having any combination or sub-combination of any features and/or components from any of the embodiments described herein.

What is claimed is:

1. A method, comprising:
receiving a definition of a success event associated with a campaign that has a plurality of campaign parameters;
calculating an impact estimate for a performance measure of the success event based on a plurality of auction parameters and a plurality of historical data associated with a browser, the plurality of historical data excluding data for advertisements previously accessed by the browser;
defining a bidding function based on the impact estimate, a plurality of characteristics of the browser, and the plurality of campaign parameters;
calculating, after the calculating the impact estimate and the defining the bidding function, a bid value using the bidding function; and
sending a signal having the bid value to a real-time bidding exchange.

2. The method of claim 1, wherein the bidding function is based on at least one of (1) an expected value of an auction associated with the campaign, (2) a product of a base bid value associated with the auction and a relative value of the auction, (3) a step function on the relative value of the auction, or (4) a monotonic transformation of an opportunity of the auction.

3. The method of claim 1, wherein:
the campaign is associated with a brand;
the success event is at least one of (1) a click at a user device on an advertisement associated with the brand, (2) an online purchase associated with the brand at a user device, (3) a visit to a website associated with the brand at a user device, or (4) an action associated with the brand and at a user device on which an impression associated with the brand was displayed.

4. The method of claim 1, wherein:
the campaign is associated with a brand;
the plurality of characteristics of the browser include information representing a bid request submitted by the browser before calculating the impact estimate and associated with the brand, and information representing an action associated with the browser and associated with the brand.

5. The method of claim 1, wherein:
the campaign is associated with a brand;
the plurality of characteristics of the browser include information representing an impression displayed at the browser before calculating the impact estimate and associated with the brand, and information representing an action associated with the browser and associated with the brand.

6. The method of claim 1, wherein:
the campaign is associated with a brand;
the success event is a visit to an interaction site associated with the brand, the bid value is based on a ratio of (1) a probability of the success event given the browser and an auction inventory and (2) an expected probability of the success event given the browser divided for auction inventories,
the probability of the success event and the expected probability of the success event each being based on information representing auctions before calculating the impact estimate and information representing visits to a website associated with the brand.

7. A method, comprising:
sending, to a browser, monitor information configured to record a plurality of events associated with the browser and a plurality of interaction sites;
receiving monitor information associated with the browser and based on the monitor information;
associating the browser with a segment from a plurality of segments based on the monitor information;
calculating an impact estimate for a performance measure based on a plurality of auction parameters and the segment and not based on data for advertisements previously accessed by the browser;
defining a bidding function based on the impact estimate, the segment, and a plurality of campaign parameters;
calculating, after the calculating the impact estimate and the defining the bidding function, a bid value using the bidding function; and
sending a signal having the bid value to a real-time bidding exchange.

8. The method of claim 7, wherein the bidding function is based on at least one of (1) an expected value of an auction associated with the campaign, (2) a product of a base bid value associated with the auction and a relative value of the auction, (3) a step function on the relative value of the auction, or (4) a monotonic transformation of an opportunity of the auction.

9. The method of claim 7, wherein:
the campaign is associated with a brand;
an event from the plurality of events is at least one of (1) a click at a user device on an advertisement associated with the brand, (2) an online purchase associated with the brand at a user device, (3) a visit to a website associated with the brand at a user device, or (4) an action associated with the brand and at a user device on which an impression associated with the brand was displayed.

10. The method of claim 1, wherein:
the campaign is associated with a brand;
an event from the plurality of events is a visit to an interaction site associated with the brand, the bid value is based on a ratio of (1) a probability of the event given the browser and an auction inventory and (2) an expected probability of the event given the browser divided for auction inventories,
the probability of the event and the expected probability of the s event each being based on information representing auctions before calculating the impact estimate and information representing visits to a website associated with the brand.

11. A method, comprising:
calculating an impact estimate for a performance measure of a success event associated with a campaign based on a plurality of parameters of an auction for the campaign and a plurality of historical data associated with a browser, the plurality of historical data excluding data for advertisements accessed by the browser;
defining a bidding function based on the impact estimate, a plurality of characteristics of the browser, and a plurality of parameters associated with the campaign;
calculating, after the calculating the impact estimate and the defining the bidding function, a bid value using the bidding function based on the plurality of parameters associated with the campaign and a value of inventory for the auction; and
sending a signal having the bid value such that the bid value is submitted to a real-time bidding exchange executing the auction.

12. The method of claim 11, wherein the bidding function is based on at least one of (1) an expected value of an auction associated with the campaign, (2) a product of a base bid value associated with the auction and a relative value of the auction, (3) a step function on the relative value of the auction, or (4) a monotonic transformation of an opportunity of the auction.

13. The method of claim 11, wherein:
the campaign is associated with a brand;
the success event is at least one of (1) a click at a user device on an advertisement associated with the brand, (2) an online purchase associated with the brand at a user device, (3) a visit to a website associated with the brand at a user device, or (4) an action associated with the brand and at a user device on which an impression associated with the brand was displayed.

14. The method of claim 11, wherein:
the campaign is associated with a brand;
the plurality of characteristics of the browser include information representing a bid request submitted by the browser before calculating the impact estimate and associated with the brand, and information representing an action associated with the browser and associated with the brand.

15. The method of claim 11, wherein:
the campaign is associated with a brand;
the plurality of characteristics of the browser include information representing an impression displayed at the browser before calculating the impact estimate and associated with the brand, and information representing an action associated with the browser and associated with the brand.

16. The method of claim 11, wherein:
the campaign is associated with a brand;
the success event is a visit to an interaction site associated with the brand, the bid value is based on a ratio of (1) a probability of the success event given the browser and an auction inventory and (2) an expected probability of the success event given the browser divided for auction inventories,
the probability of the success event and the expected probability of the success event each being based on information representing auctions before calculating the impact estimate and information representing visits to a website associated with the brand.
